(19) United States
(12) Patent Application Publication
(10) Pub. No.: US 2021/0146745 A1
(43) Pub. Date: May 20, 2021

(54) AIR CONDITIONING DEVICE FOR VEHICLE

(71) Applicant: Toyota Jidosha Kabushiki Kaisha, Toyota-shi Aichi-ken (JP)

(72) Inventors: Rino Oshikiri, Toyota-shi (JP); Hidekazu Hirabayashi, Toyota-shi (JP); Takayuki Shimauchi, Toyota-shi (JP)

(21) Appl. No.: 16/950,528

(22) Filed: Nov. 17, 2020

(30) Foreign Application Priority Data
Nov. 20, 2019 (JP) 2019-209644

(51) Int. Cl. B60H 1/00; B60H 1/03; B60H 3/06

(52) U.S. Cl. CPC B60H 1/008; B60H 1/004; B60H 1/00828; B60H 3/0608; B60H 1/03

(57) ABSTRACT

An air conditioning device for a vehicle is provided in which air cleaning control can be executed to reduce a concentration of floating particulate substances in a vehicle cabin by increasing an air volume passing through a filter by further increasing an air volume blowing out from a blower outlet into the vehicle cabin from an air volume which is necessary for cabin temperature control or an air volume which is set by a passenger of the vehicle, and in which, under an air conditioning condition in which an increase of the cabin temperature is strongly demanded, when a fluid temperature of a fluid which is a heat source of indoor heating is lower than a predetermined fluid temperature, an upper limit value permitted as an amount of increase of an air volume by the air cleaning control is inhibited.

### CROSS REFERENCE TO RELATED APPLICATION

This application claims priority to Japanese Patent Application No. 2019-209644 filed on Nov. 20, 2019, which is incorporated herein by reference in its entirety including the specification, claims, drawings, and abstract.

### TECHNICAL FIELD

The present disclosure relates to an air condition device for a vehicle in which air cleaning control can be executed to reduce a concentration of floating particulate substances in a vehicle cabin by increasing an air volume passing through a filter by further increasing an air volume blown from a blower outlet into the vehicle cabin according to the concentration of the floating particular substances in the vehicle cabin.

### BACKGROUND

JP 2003-025831 A discloses an air conditioning device for a vehicle, having a function to automatically switch between an inside air (recirculation) mode and an outside air mode according to a degree of contamination of the outside air.

During air cleaning control to reduce a concentration of floating particular substances in a vehicle cabin by increasing an air volume to increase an air volume passing through a filter, when a fluid temperature of a fluid which is a heat source for indoor heating is low under an air conditioning condition in which an increase of the cabin temperature is strongly demanded such as immediately after riding a vehicle during a period of low air temperature such as in the winter time, the air volume passing through a heater core in which the fluid which is the heat source for the indoor heating passes through a tube is increased, resulting in obstruction of the temperature increase of the fluid. When the temperature increase of the fluid which is the heat source for the indoor heating is obstructed in this manner, a fuel consumption or an electric power consumption of the vehicle may be degraded because the fuel consumption may be degraded as the temperature increase of the fluid takes a long period of time, a consumed electric power of a heater which heats the fluid may be increased, or the consumed electric power may be increased due to a change in an operation point of a heat pump and resulting inability to execute a steady-state operation having a high efficiency.

In addition, when the air volume is increased in the case where the fluid temperature of the fluid which is the heat source for the indoor heating is low under the air conditioning condition in which the increase of the cabin temperature is strongly demanded as described above, a cold air flow blowing out from the blower outlet into the vehicle cabin blows onto passengers of the vehicle, resulting in discomfort for the passengers.

In some embodiments, the present disclosure inhibits degradation of the fuel consumption or the electric power consumption of the vehicle due to the air cleaning control and reduces the discomfort of the passengers due to the cold air flow when the fluid temperature of the fluid which is the heat source for the indoor heating is low under an air conditioning condition in which the increase of the cabin temperature is strongly demanded.

### SUMMARY

According to one aspect of the present disclosure, there is provided an air conditioning device for a vehicle in which air cleaning control can be executed to reduce a concentration of floating particulate substances in a vehicle cabin by increasing an air volume passing through a filter by further increasing an air volume blowing out from a blower outlet into the vehicle cabin from an air volume which is necessary for cabin temperature control or an air volume which is set by a passenger of the vehicle, by an air volume according to the concentration of the floating particulate substances in the vehicle cabin, wherein, under an air conditioning condition in which an increase of the cabin temperature is strongly demanded, when a fluid temperature of a fluid which is a heat source for indoor heating is lower than a predetermined fluid temperature, an upper limit value permitted as an amount of increase of air volume by the air cleaning control is inhibited.

As described, in an air conditioning device for a vehicle in which air cleaning control can be executed to reduce a concentration of floating particulate substances in a vehicle cabin by increasing an air volume passing through a filter by further increasing an air volume blowing out from a blower outlet into the vehicle cabin from an air volume which is necessary for cabin temperature control or an air volume which is set by a passenger of the vehicle, according to the concentration of the floating particulate substances in the vehicle cabin, under an air conditioning condition in which an increase of the cabin temperature is strongly demanded, when a fluid temperature of a fluid which is a heat source for indoor heating is lower than a predetermined fluid temperature, an upper limit value permitted as an amount of increase of air volume by the air cleaning control is inhibited, and thus, the amount of heat taken away in the heater core can be reduced, the degradation of the fuel consumption and the electric power consumption of the vehicle due to the air cleaning control can be inhibited, and the discomfort of the passengers due to the cold air flow can be reduced.

According to another aspect of the present disclosure, in the air conditioning device for the vehicle, it may be determined that the air conditioning condition is satisfied when an outside air temperature is lower than a predetermined outside air temperature and the cabin temperature is lower than a predetermined cabin temperature.

According to this configuration, it is determined that the air conditioning condition is a condition in which an increase of the cabin temperature is strongly demanded when the outside air temperature is lower than the predetermined outside air temperature and the cabin temperature is lower than the predetermined cabin temperature, and, when the fluid temperature of the fluid which is the heat source for the indoor heating is lower than the predetermined fluid temperature, the upper limit value permitted as the amount of increase of the air volume by the air cleaning control is inhibited. Thus, the degradation of the fuel consumption and the electric power consumption of the vehicle due to the air cleaning control can be inhibited and the discomfort of the passengers due to the cold air flow can be reduced.

According to another aspect of the present disclosure, in the air conditioning device for the vehicle, it may be determined that the air conditioning condition is satisfied when a target blow-out temperature which is a target temperature of air blowing out from the blower outlet into the vehicle cabin for maintaining the cabin temperature at a set temperature is higher than a predetermined temperature.

According to this configuration, it is determined that the air conditioning condition is a condition in which the increase of the cabin temperature is strongly demanded when the target blow-out temperature which is the target temperature of the air blowing out from the blower outlet into the vehicle cabin for maintaining the cabin temperature at a set temperature is higher than a predetermined temperature, and, when the fluid temperature of the fluid which is the heat source for the indoor heating is lower than the predetermined fluid temperature, the upper limit value permitted as the amount of increase of the air volume by the air cleaning control is inhibited. Thus, the degradation of the fuel consumption and the electric power consumption of the vehicle due to the air cleaning control can be inhibited, and the discomfort of the passengers due to the cold air flow can be reduced.

According to another aspect of the present disclosure, the air conditioning device for the vehicle may further comprise a heater which heats the fluid, wherein, in a case in which the heater is heating the fluid, under the air conditioning condition in which the increase of the cabin temperature is strongly demanded, when the fluid temperature of the fluid which is the heat source for the indoor heating is lower than the predetermined fluid temperature, the upper limit value may be inhibited.

According to this configuration, in an air conditioning device for a vehicle having a heater which heats the fluid which is the heat source for the indoor heating, in the case in which the heater is heating the fluid, under the air conditioning condition in which the increase of the cabin temperature is strongly demanded, when the fluid temperature of the fluid which is the heat source for the indoor heating is lower than the predetermined fluid temperature, the upper limit value permitted as the amount of increase of the air volume by the air cleaning control is inhibited, so that the increase of the consumed electric power of the heater can be inhibited. Thus, the degradation of the fuel consumption and the electric power consumption of the vehicle due to the air cleaning control can be inhibited.

According to another aspect of the present disclosure, the air conditioning device for the vehicle may further comprise a heat pump for indoor heating, wherein, in a case in which the heat pump is heating air blowing into the vehicle cabin, under the air conditioning condition in which the increase of the cabin temperature is strongly demanded, when the fluid temperature of the fluid which is the heat source for the indoor heating is lower than the predetermined fluid temperature, the upper limit value may be inhibited.

According to this configuration, in an air conditioning device for a vehicle having a heat pump for indoor heating, in the case in which the heat pump is heating the air blown into the vehicle cabin, under the air conditioning condition in which the increase of the cabin temperature is strongly demanded, when the fluid temperature of the fluid which is the heat source for the indoor heating is lower than the predetermined fluid temperature, the upper limit value permitted as the amount of increase of the air volume by the air cleaning control is inhibited, so that an increase in the consumed electric power of the heat pump can be inhibited. Thus, the degradation of the fuel consumption and the electric power consumption of the vehicle due to the air cleaning control can be inhibited.

According to another aspect of the present disclosure, in the air conditioning device for the vehicle, in a case in which an economy mode intended to improve fuel consumption in comparison to a standard mode is selected as a traveling mode of the vehicle, under an air conditioning condition in which an increase of the cabin temperature is strongly demanded, when the fluid temperature of the fluid which is the heat source for the indoor heating is lower than the predetermined fluid temperature, the upper limit value may be inhibited.

According to this configuration, in a case in which the economy mode intended to improve the fuel consumption in comparison to the standard mode is selected as the traveling mode of the vehicle, under the air conditioning condition in which the increase of the cabin temperature is strongly demanded, when the fluid temperature of the fluid which is the heat source for the indoor heating is lower than the predetermined fluid temperature, the upper limit value permitted as the amount of increase of the air volume by the air cleaning control is inhibited. Thus, the degradation of the fuel consumption and the electric power consumption of the vehicle due to the air cleaning control can be inhibited, and the discomfort of the passengers due to the cold air flow can be reduced.

According to another aspect of the present disclosure, the air conditioning device for the vehicle may be equipped on a hybrid electric vehicle, and, in a case in which an EV mode which uses a main battery as a motive power source for traveling is selected as a traveling mode of the hybrid electric vehicle, under the air conditioning condition in which the increase of the cabin temperature is strongly demanded, when the fluid temperature of the fluid which is the heat source for the indoor heating is lower than the predetermined fluid temperature, the upper limit value may be inhibited.

According to this configuration, in the hybrid electric vehicle, in the case in which the EV mode which uses the main battery as a motive power source for traveling is selected as the traveling mode of the hybrid electric vehicle, under the air conditioning condition in which the increase of the cabin temperature is strongly demanded, when the fluid temperature of the fluid which is the heat source for the indoor heating is lower than the predetermined fluid temperature, the upper limit value permitted as the amount of increase of the air volume by the air cleaning control is inhibited. Thus, the degradation of the fuel consumption and the electric power consumption of the vehicle due to the air cleaning control can be inhibited, and the discomfort of the passengers due to the cold air flow can be reduced.

In the present disclosure, under the air conditioning condition in which the increase of the cabin temperature is strongly demanded, when the fluid temperature of the fluid which is the heat source for the indoor heating is lower than the predetermined fluid temperature, the upper limit value permitted as the amount of increase of the air volume by the air cleaning control is inhibited, so that the amount of heat taken away in the heater core can be reduced. Thus, the degradation of the fuel consumption and the electric power consumption of the vehicle due to the air cleaning control can be inhibited, and the discomfort of the passengers of the vehicle due to blowing of cold air flow can be inhibited.

### BRIEF DESCRIPTION OF DRAWINGS

Embodiment(s) of the present disclosure will be described based on the following figures, wherein:

FIG. 1 is a diagram showing a control system of a control device of an air conditioning device for a vehicle according to a first configuration;

FIG. 2 is a flowchart exemplifying a control routine executed by a control device of the air conditioning device for a vehicle according to the first configuration;

FIG. 3 is a diagram showing a relationship between a level of a concentration of floating particulate substances in a vehicle cabin and a level of an amount of increase of an air volume by air cleaning control;

FIG. 4 is a diagram showing a relationship between an upper limit value of an amount of increase of an air volume in air cleaning control, in which the upper limit value is not inhibited, and an outside air temperature;

FIG. 5 is a diagram showing a relationship between an upper limit value of an amount of increase of an air volume in air cleaning control, in which the upper limit value is inhibited, and an outside air temperature;

FIG. 6 is a flowchart exemplifying a control routine executed by a control device of an air conditioning device for a vehicle according to a second configuration;

FIG. 7 is a flowchart exemplifying a control routine executed by a control device of an air conditioning device for a vehicle according to a third configuration;

FIG. 8 is a flowchart exemplifying a control routine executed by a control device of an air conditioning device for a vehicle according to a fourth configuration;

FIG. 9 is a diagram showing a relationship between an amount of increase of an air volume in air cleaning control, in which an upper limit value of the amount of increase of the air volume is inhibited, and an amount of correction of a duty ratio of an outdoor unit fan of a heat pump;

FIG. 10 is a flowchart exemplifying a control routine executed by a control device of an air conditioning device for a vehicle according to a fifth configuration: and

FIG. 11 is a flowchart exemplifying a control routine executed by a control device of an air conditioning device for a vehicle according to a sixth configuration.

### DESCRIPTION OF EMBODIMENTS

### <First Configuration>

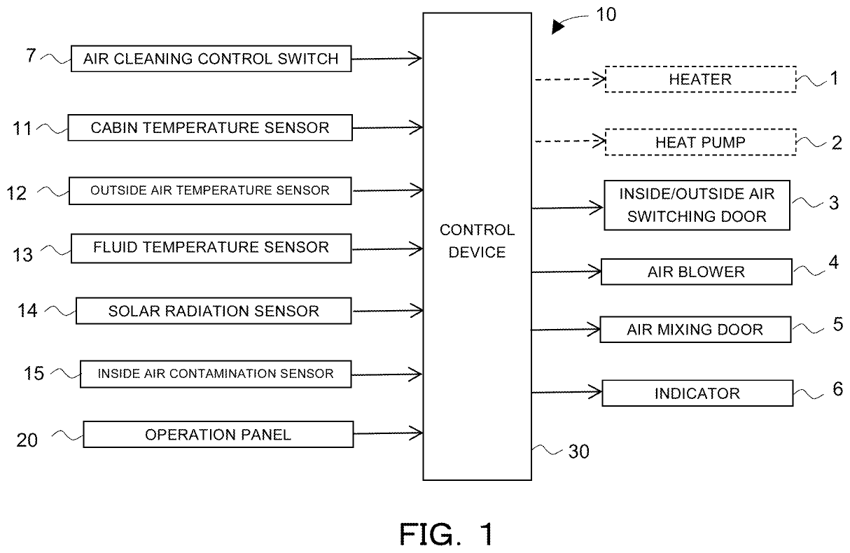

An air conditioning device 10 for a vehicle according to a first configuration will now be described with reference to FIGS. 1 to 5. The air conditioning device 10 for vehicle is a device which executes air conditioning in a vehicle cabin, and may be equipped on any of a vehicle which uses an engine as a motive power source for traveling, a hybrid electric vehicle, and an electric vehicle. In the vehicle which uses the engine as the motive power source for traveling, the air conditioning device 10 for vehicle has a heater core in which an engine cooling fluid passes through a tube as a heat exchanger for indoor heating. In the hybrid electric vehicle, the air conditioning device 10 for vehicle may further comprise a heater 1 or a heat pump 2 which heats the engine cooling fluid. Further, in the electric vehicle, the air conditioning device 10 for vehicle may comprise the heater core for indoor heating and a heater 1 which heats the fluid passing through the tube of the heater core, or may comprise a heat pump 2 for indoor heating.

As shown in FIG. 1, the air conditioning device 10 for vehicle comprises an inside/outside air switching door 3, an air blower 4, an air mixing door 5, an indicator 6, an air cleaning control switch 7, a cabin temperature sensor 11, an outside air temperature sensor 12, a fluid temperature sensor 13, a solar radiation sensor 14, an inside air contamination sensor 15, an operation panel 20, and a control device 30. The control device 30 controls the inside/outside air switching door 3, the air blower 4, the air mixing door 5, and the indicator 6. Further, when the air conditioning device 10 for vehicle comprises the heater 1 and/or the heat pump 2, the control device 30 also controls the heater 1 and/or the heat pump 2.

The air conditioning device 10 for vehicle has an air passage through which an air flow is sent toward the inside of the vehicle cabin, and an inside air introduction port, an outside air introduction port, and the inside/outside air switching door 3 are placed at an uppermost stream part of the air passage. In the air conditioning device 10 for vehicle, with an operation of the inside/outside air switching door 3, an air mode can be switched between an inside air mode in which the inside air is introduced from the inside air introduction port and the inside air is recirculated, and an outside air mode in which the outside air is introduced from the outside air introduction port.

In the air passage, the air blower 4 which generates an air flow toward the inside of the vehicle cabin is placed at a downstream side of the inside/outside air switching door 3. A heater core which heats the air flowing in the air passage is placed at a downstream side of the air blower 4, and a bypass passage is formed in which the air flows while bypassing the heater core. The air mixing door 5 is rotatably placed between the air blower 4 and the heater core. By virtue of this configuration, in the air conditioning device 10 for vehicle, a ratio between a volume of air passing through the heater core (volume of warm air) and a volume of an air flowing in the bypass passage and bypassing the heater core (volume of cold air) can be adjusted by a degree of opening of the air mixing door 5, to thereby adjust a temperature of the air blowing out from a blower outlet into the vehicle cabin.

The cabin temperature sensor 11 detects a temperature of the air in the vehicle cabin. The outside air temperature sensor 12 detects the temperature of the air outside of the vehicle. The fluid temperature sensor 13 detects a temperature of fluid circulating in the tube of the heater core. The solar radiation sensor 14 detects an amount of solar radiation. The inside air contamination sensor 15 detects a concentration of floating particulate substances such as PM 2.5 contained in the air in the vehicle cabin. As shown in FIG. 1, output signals of these sensors are input to the control device 30.

A passenger of the vehicle can input a temperature setting in the vehicle cabin and an air volume setting of the air blower 4 by operating the operation panel 20. For example, when the passenger inputs an air volume setting in the operation panel 20, the control device 30 controls the air blower 4, so that the air volume which is set by the passenger is realized.

When the passenger inputs the temperature setting in the operation panel 20, the control device 30 calculates a target blow-out temperature TAO (Temperature Air Outlet) of the air blowing out from the blower outlet into the vehicle cabin based on the temperature setting, the inside air temperature, the outside air temperature, and the solar radiation, and determines an air volume of the air blower 4 and the degree of opening of the air mixing door 5 based on the TAO and the fluid temperature, to thereby control the air blower 4 and the air mixing door 5. The determined air volume is the air volume necessary or required for cabin temperature control, which controls the inside air temperature to reach the temperature setting input by the passenger in the operation panel, is blown out the air blower 4.

The concentration of the floating particulate substances detected by the inside air contamination sensor 15 is displayed on the indicator 6 placed in the vehicle cabin. The passenger of the vehicle views the display of the indicator 6, and, when the passenger judges that air cleaning in the vehicle cabin is necessary, the passenger switches the air cleaning control switch 7 ON, to start air cleaning control for reducing the concentration of the floating particulate substances in the vehicle cabin.

When the air cleaning control is executed, the control device 30 sets the inside/outside air switching door 3 to the inside air mode, and reduces the concentration of the floating particulate substances in the vehicle cabin by increasing an air volume passing through a filter provided on the air passage by further increasing the air volume from the blower outlet into the vehicle cabin from the air volume which is necessary for the cabin temperature control or the air volume which is set by the passenger of the vehicle, according to the concentration of the floating particulate substances in the vehicle cabin. When the passenger of the vehicle views the display of the indicator 6 and judges that the air cleaning control should be completed because the concentration of the flowing particulate substances in the vehicle cabin is sufficiently reduced, the passenger may switch the air cleaning control switch 7 OFF, and complete the air cleaning control.

On the other hand, when the air volume of the air blower 4 is increased for the air cleaning control, an air volume passing through the heater core is also increased. Because of this, under an air conditioning condition in which an increase of the cabin temperature is strongly demanded such as immediately after riding the vehicle during a period of low temperature such as in the winter time, when a fluid temperature of a fluid which is a heat source for indoor heating is lower than a predetermined fluid temperature, the increase in the temperature of the fluid is obstructed. When the temperature increase of the fluid which is the heat source for the indoor heating is obstructed, the temperature increase of the fluid may require a longer time period, resulting in degraded fuel consumption or an increase in the consumed electric power of the heater 1 which heats the fluid, or an operation point of the heat pump 2 may change, resulting in an inability to execute a steady state operation having a high efficiency, resulting in an increase in the consumed electric power. Consequently, the fuel consumption and the electric power consumption of the vehicle may be degraded. In addition, under the air conditioning condition in which the increase of the cabin temperature is strongly demanded, when the fluid temperature of the fluid which is the heat source for the indoor heating is low, if the air volume is increased, a cold air flow blown from the blower outlet into the vehicle cabin is experienced by the passenger of the vehicle, resulting in discomfort of the passenger.

In consideration of this, under the air conditioning condition in which the increase of the cabin temperature is strongly demanded, when the fluid temperature of the fluid which is the heat source for the indoor heating is lower than a predetermined fluid temperature, the control device 30 controls the air blower 4 in a manner to inhibit an upper limit value permitted as an amount of increase of the air volume by the air cleaning control. The control by the control device 30 related to the air cleaning control will now be described in detail.

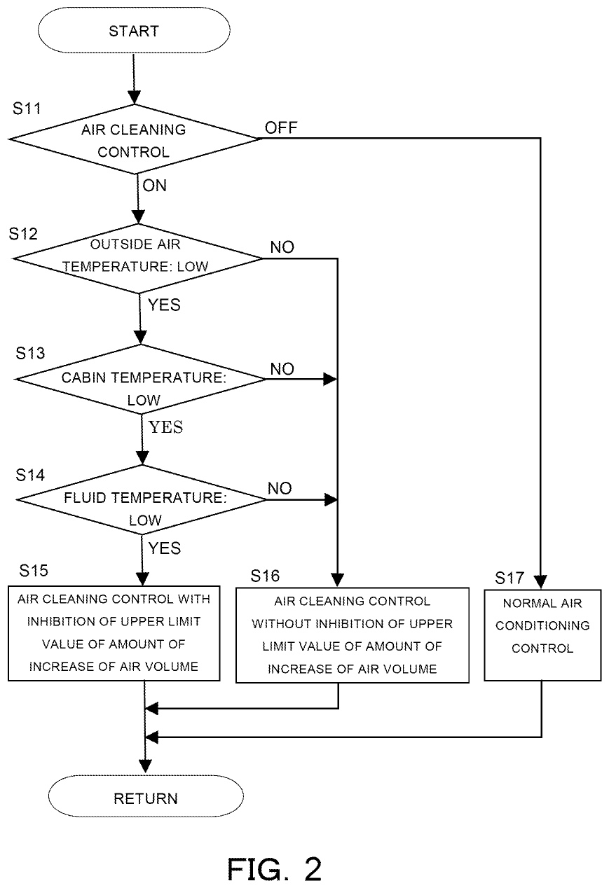

The control device 30 includes a CPU which is a calculation processor, and a storage unit such as a RAM and a ROM, and controls the air conditioning device 10 for vehicle by executing a signal processing according to a program which is stored in the ROM in advance while using a temporary storage function of the RAM. FIG. 2 is a flowchart showing a control routine of the control device 30. A program of the control routine of FIG. 2 is stored in the ROM of the control device 30, and is repeatedly executed at a very short cycle time of, for example, about a few msec.

In the control routine of FIG. 2, when an ignition switch of the vehicle is set ON and the control device 30 is started, first, in step S11, a determination is made as to whether or not the air cleaning control switch 7 is in an ON state. When the air cleaning control switch 7 is in the ON state, the processing proceeds from step S11 to step S12. On the other hand, when the air cleaning control switch 7 is in the OFF state, the processing proceeds from step S11 to step S17. In this case, the air cleaning control is not executed, and normal air conditioning control is executed. The normal air conditioning control is control in which, for example, when the passenger of the vehicle inputs the temperature setting by the operation panel 20, the control device 30 controls the air blower 4 and the air mixing door 5 so that the air volume which is necessary or required for the cabin temperature control is blown out from the air blower 4 such that the cabin temperature is set at the temperature setting.

When the processing proceeds from step S11 to step S12, in step S12, a determination is made as to whether or not the outside air temperature is lower than a predetermined outside air temperature. When the outside air temperature is lower than the predetermined outside air temperature, the processing proceeds from step S12 to step S13, and, when the outside air temperature is higher than or equal to the predetermined outside air temperature, the processing proceeds from step S12 to step S16. The predetermined outside air temperature is stored in the ROM of the control device 30, and the control device 30 executes the determination in step S12 based on the predetermined outside air temperature stored in the ROM.

When the processing proceeds from step S12 to step S13, in step S13, a determination is made as to whether or not a temperature of the air in the vehicle cabin (hereinafter, referred to as “cabin temperature”) is lower than a predetermined cabin temperature. When the cabin temperature is lower than the predetermined cabin temperature, the processing proceeds from step S13 to step S14, and, when the cabin temperature is higher than or equal to the predetermined cabin temperature, the processing proceeds from step S13 to step S16. The predetermined cabin temperature is stored in the ROM of the control device 30, and the control device 30 executes the determination in step S13 based on the predetermined cabin temperature stored in the ROM.

When the processing proceeds from step S13 to step S14, in step S14, a determination is made as to whether or not the fluid temperature is lower than a predetermined fluid temperature. When the fluid temperature is lower than the predetermined fluid temperature, the processing proceeds from step S14 to step S15, and, when the fluid temperature is higher than or equal to the predetermined fluid temperature, the processing proceeds from step S14 to step S16. The predetermined fluid temperature is stored in the ROM of the control device 30, and the control device 30 executes the determination in step S14 based on the predetermined fluid temperature stored in the ROM.

When the processing proceeds to step S16 from step S12, step S13, or step S14, in step S16, the control device 30 executes “air cleaning control without inhibition of an upper limit value of an amount of increase of air volume”. In the “air cleaning control without the inhibition of the upper limit value of the amount of increase of the air volume”, first, the control device 30 sets the inside/outside air switching door 3 to the inside air mode.

After the inside/outside air switching door 3 is set to the inside air mode, the control device 30 executes an answer-back increase of an air volume. The answer-back increase of the air volume refers to a temporary increase of the air volume of the air blower 4 at once. A reason for the answer-back increase of the air volume is to cause the passenger to recognize that the air cleaning control is started, by uniformly increasing the air volume immediately after the air cleaning control is started as a result of the passenger of the vehicle operating the operation panel 20, regardless of the concentration of the floating particulate substances in the vehicle cabin.

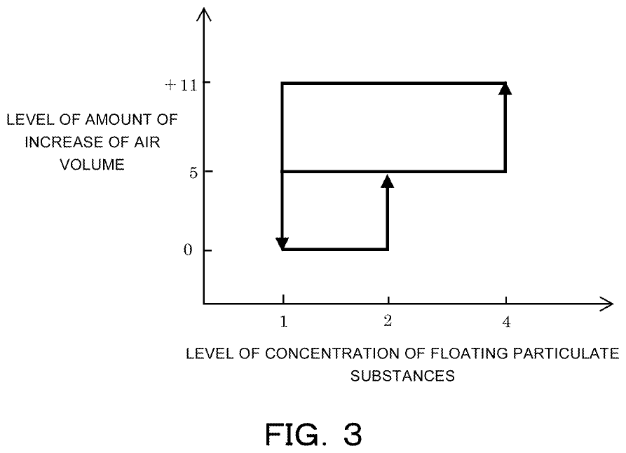

After the answer-back increase of the air volume is executed in this manner, the control device 30 calculates an amount of increase of the air volume according to the concentration of the floating particulate substances in the vehicle cabin. FIG. 3 shows a relationship between a level of the concentration of the floating particulate substances in the vehicle cabin and a level of the amount of increase of the air volume. This relationship is stored in the ROM of the control device 30, and the control device 30 calculates the level of the amount of increase of the air volume according to the level of the concentration of the floating particulate substances in the vehicle cabin, based on the relationship stored in the ROM and shown in FIG. 3.

As shown in FIG. 3, the level of the amount of increase of the air volume changes in three stages, including 0, +5, and +11. As shown by arrows of solid lines of FIG. 3, a path on the graph of FIG. 3 differs between a case in which the concentration of the floating particulate substances in the vehicle cabin is increasing and a case in which the concentration is decreasing. For example, in a period of increase of the level of the concentration of the floating particulate substances from 2 to 4, the level of the amount of increase of the air volume is +5; the level of the amount of increase of the air volume is +11 when the level of the concentration of the floating particulate substances reaches 4; and then, the level of the amount of increase of the air volume is maintained at +11 in a period in which the level of the concentration of the floating particulate substances decreases from 4 to 1.

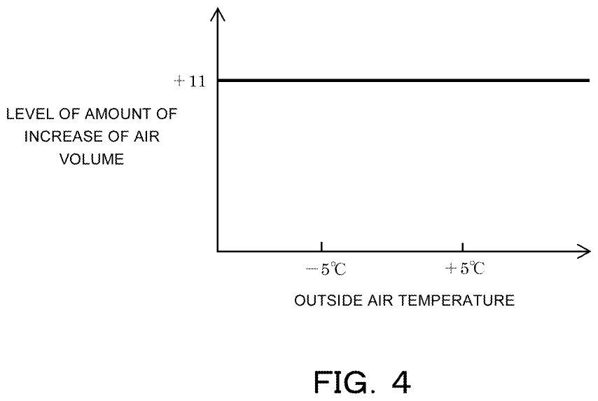

After the amount of increase of the air volume according to the concentration of the floating particulate substances in the vehicle cabin is calculated as described above, the control device 30 controls the air blower 4 so that the air volume blown from the air blower 4 is further increased from the air volume which is necessary for the cabin temperature control or the air volume which is set by the passenger of the vehicle, by the amount of increase of the air volume calculated according to the concentration of the floating particulate substances. As shown in FIG. 4, an upper limit value permitted as the amount of increase of the air volume by the air cleaning control is the level of +11 regardless of the outside air temperature, and is constant.

On the other hand, when the processing proceeds from step S14 to step S15, the control device 30 executes “air cleaning control with the inhibition of the upper limit value of the amount of increase of the air volume”.

The “air cleaning control with the inhibition of the upper limit value of the amount of increase of the air volume” is similar to the “air cleaning control without the inhibition of the upper limit value of the amount of increase of the air volume” in that the answer-back increase of the air volume is executed after the inside/outside air switching door 3 is set to the inside air mode, and in that the amount of increase of the air volume according to the concentration of the floating particulate substances in the vehicle cabin is calculated based on the relationship shown in FIG. 3.

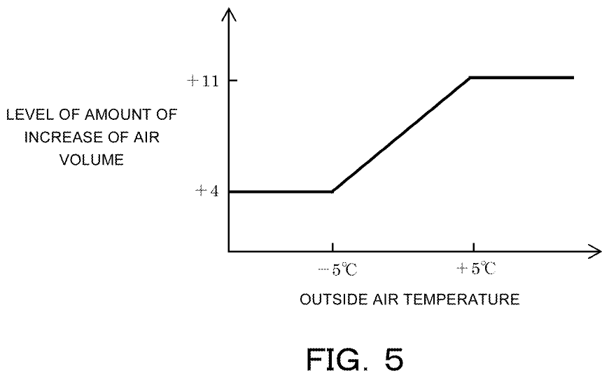

However, the “air cleaning control with the inhibition of the upper limit value of the amount of increase of the air volume” differs from the “air cleaning control without the inhibition of the upper limit value of the amount of increase of the air volume” in that an upper limit value which varies depending on the outside air temperature as shown in FIG. 5 is set as an upper limit value permitted as the amount of increase of the air volume, and in that the control device 30 controls the air blower 4 so that air flow is realized in which the air volume is further increased from the air volume which is necessary for the cabin temperature control or the air volume which is set by the passenger of the vehicle by the amount of increase of the air volume calculated according to the concentration of the floating particulate substances within a range which does not exceed the set upper limit value. A relationship between the upper limit value of the amount of increase of the air volume and the outside air temperature shown in FIG. 5 is stored in the ROM of the control device 30, and the control device 30 calculates the upper limit value of the amount of increase of the air volume from the outside air temperature, based on the relationship stored in the ROM and shown in FIG. 5.

In this manner, in the air conditioning device 10 for vehicle, the processing reaches step S15 shown in FIG. 2 when the outside air temperature is lower than the predetermined outside air temperature, the cabin temperature is lower than the predetermined cabin temperature, and the fluid temperature is lower than the predetermined fluid temperature, and the upper limit value permitted as the amount of increase of the air volume by the air cleaning control is inhibited as shown in FIG. 5. The predetermined outside air temperature is +5° C. as shown in FIG. 5. In the air conditioning device 10 for vehicle, when the outside air temperature is lower than +5° C. and the cabin temperature is lower than the predetermined cabin temperature, it is judged that a heat source is necessary for indoor heating, and that the air conditioning condition is a condition in which an increase of the cabin temperature is strongly demanded. Under such an air conditioning condition in which the increase of the cabin temperature is strongly demanded, if the fluid temperature is lower than the predetermined fluid temperature, it is judged that the heat source is insufficient, and the upper limit value which varies depending on the outside air temperature as shown in FIG. 5 is set as the upper limit value permitted as the amount of increase of the air volume.

Because of this, in the air conditioning device 10 for vehicle, under the air conditioning condition in which the increase of the cabin temperature is strongly demanded, when the fluid temperature of the fluid which is the heat source for the indoor heating is lower than the predetermined fluid temperature, the upper limit value permitted as the amount of increase of the air volume by the air cleaning control is inhibited. As a consequence, the degradation of the fuel consumption and the electric power consumption of the vehicle due to the air cleaning control can be inhibited and discomfort of the passengers due to the cold air flow can be reduced.

### <Second Configuration>

Next, an air conditioning device for vehicle according to a second configuration will be described with reference to FIGS. 3 to 6. The air conditioning device for vehicle of the second configuration has a structure similar to that of the air conditioning device 10 for vehicle of the first configuration, and differs from the air conditioning device 10 for vehicle of the first configuration only in the control routine executed by the control device 30. Therefore, only a control routine executed by the control device 30 of the air conditioning device for vehicle of the second configuration will be described, and descriptions of other structures will not be repeated.

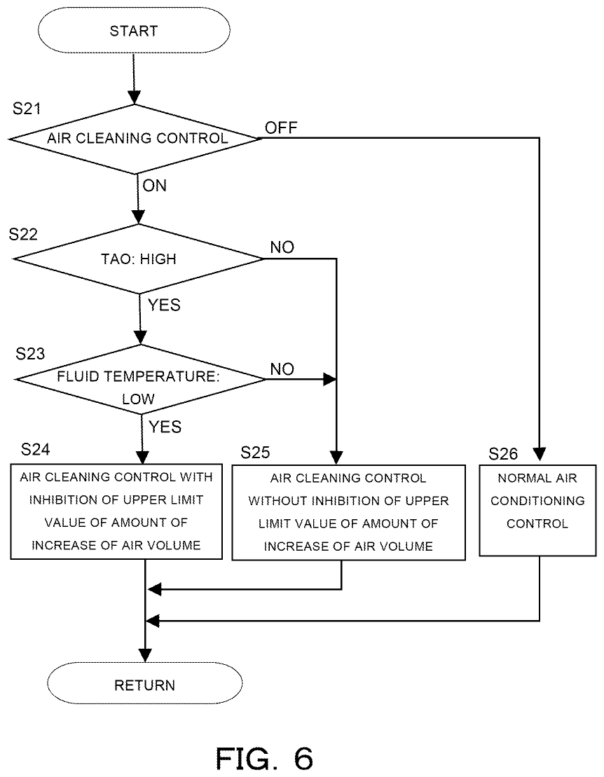

FIG. 6 is a flowchart showing a control routine of the control device 30. A program of the control routine of FIG. 6 is stored in the ROM of the control device 30, and is repeatedly executed at a very short cycle time of, for example, about a few msec.

In the control routine shown in FIG. 6, when the ignition switch of the vehicle is set ON and the control device 30 is started, in step S21, a determination is made as to whether or not the air cleaning control switch 7 is in the ON state. When the air cleaning control switch 7 is in the ON state, the processing proceeds from step S21 to step S22. On the other hand, when the air cleaning control switch 7 is in the OFF state, the processing proceeds from step S21 to step S26. In this case, the air cleaning control is not executed, and normal air conditioning control is executed. The normal air conditioning control is control in which, for example, when the passenger of the vehicle inputs the temperature setting in the operation panel 20, the control device 30 controls the air blower 4 and the air mixing door 5 such that the cabin temperature is set at the temperature setting.

When the processing proceeds from step S21 to step S22, in step S22, a determination is made as to whether or not the TAO is higher than a predetermined temperature. When the TAO is higher than the predetermined temperature, the processing proceeds from step S22 to step S23, and, when the TAO is lower than or equal to the predetermined temperature, the processing proceeds from step S22 to step S25. The predetermined temperature is stored in the ROM of the control device 30, and the control device 30 executes the determination in step S22 based on the predetermined temperature stored in the ROM.

When the processing proceeds from step S22 to step S23, in step S23, a determination is made as to whether or not the fluid temperature is lower than the predetermined fluid temperature. When the fluid temperature is lower than the predetermined fluid temperature, the processing proceeds from step S23 to step S24, and, when the fluid temperature is higher than or equal to the predetermined fluid temperature, the processing proceeds from step S23 to step S25. The predetermined fluid temperature is stored in the ROM of the control device 30, and the control device 30 executes the determination of step S23 based on the predetermined fluid temperature stored in the ROM.

When the processing proceeds from step S22 or step S23 to step S25, in step S25, the control device 30 executes the “air cleaning control without the inhibition of the upper limit value of the amount of increase of the air volume”, similar to step S16 of FIG. 2. In the “air cleaning control without the inhibition of the upper limit value of the amount of increase of the air volume”, first, the control device 30 sets the inside/outside air switching door 3 to the inside air mode. After the inside/outside air switching door 3 is set to the inside air mode, the control device 30 executes the answer-back increase of the air volume.

After the answer-back increase of the air volume is executed, the control device 30 calculates the amount of increase of the air volume according to the concentration of the floating particulate substances in the vehicle cabin, similar to the air conditioning device 10 for vehicle of the first configuration. FIG. 3 shows the relationship between the level of the concentration of the floating particulate substances in the vehicle cabin and the level of the amount of increase of the air volume. This relationship is stored in the ROM of the control device 30, and the control device 30 calculates the level of the amount of increase of the air volume from the level of the concentration of the floating particulate substances in the vehicle cabin based on the relationship stored in the ROM and shown in FIG. 3.

After the amount of increase of the air volume according to the concentration of the floating particulate substances in the vehicle cabin is calculated, the control device 30 controls the air blower 4 so that the air volume is further increased from the air volume which is necessary for the cabin temperature control or the air volume which is set by the passenger of the vehicle by the amount of increase of the air volume calculated according to the concentration of the floating particulate substances. As shown in FIG. 4, the upper limit value permitted as the amount of increase of the air volume by the air cleaning control is the level of +11 regardless of the outside air temperature and is constant.

On the other hand, when the processing proceeds from step S23 to step S24, the control device 30 executes the “air cleaning control with the inhibition of the upper limit value of the amount of increase of the air volume”, similar to step S15 of FIG. 2.

The “air cleaning control with the inhibition of the upper limit value of the amount of increase of the air volume” is similar to the “air cleaning control without the inhibition of the upper limit value of the amount of increase of the air volume” described above in that, after the inside/outside air switching door 3 is set to the inside air mode, the answer-back increase of the air volume is executed, and in that the amount of increase of the air volume is calculated according to the concentration of the floating particulate substances in the vehicle cabin based on the relationship shown in FIG. 3.

However, the “air cleaning control with the inhibition of the upper limit value of the amount of increase of the air volume” differs from the “air cleaning control without the inhibition of the upper limit value of the amount of increase of the air volume” in that an upper limit value which varies depending on the outside air temperature as shown in FIG. 5 is provided as the upper limit value permitted as the amount of increase of the air volume, and the control device 30 controls the air blower 4 so that the air volume is further increased from the air volume which is necessary for the cabin temperature control or the air volume which is set by the passenger of the vehicle by the amount of increase of the air volume calculated according to the concentration of the floating particulate substances within a range which does not exceed the upper limit value. The relationship between the upper limit value of the amount of increase of the air volume and the outside air temperature shown in FIG. 5 is stored in the ROM of the control device 30, and the control device 30 calculates the upper limit value of the amount of increase of the air volume from the fluid temperature based on the relationship stored in the ROM and shown in FIG. 5.

As described, in the air conditioning device for vehicle of the second configuration, the processing reaches step S24 shown in FIG. 6 when the TAO is higher than the predetermined temperature and the fluid temperature is lower than the predetermined fluid temperature, and the upper limit value permitted as the amount of increase of the air volume by the air cleaning control is inhibited as shown in FIG. 5. In the air conditioning device for vehicle of the second configuration, the air conditioning condition is judged as the air conditioning condition in which the increase of the cabin temperature is strongly demanded when the TAO is higher than the predetermined temperature. Under the air conditioning condition in which the increase of the cabin temperature is strongly demanded, when the fluid temperature is lower than the predetermined fluid temperature, it is judged that the heat source is insufficient, and the upper limit value which varies depending on the outside air temperature as shown in FIG. 5 is provided as the upper limit value permitted as the amount of increase of the air volume.

Because of this, in the air conditioning device for vehicle of the second configuration, under the air conditioning condition in which the increase of the cabin temperature is strongly demanded, when the fluid temperature of the fluid which is the heat source for the indoor heating is lower than the predetermined fluid temperature, the upper limit value permitted as the amount of increase of the air volume by the air cleaning control is inhibited. As a consequence, the degradation of the fuel consumption and the electric power consumption due to the air cleaning control can be inhibited and the discomfort of the passengers due to the cold air flow can be reduced.

### <Third Configuration>

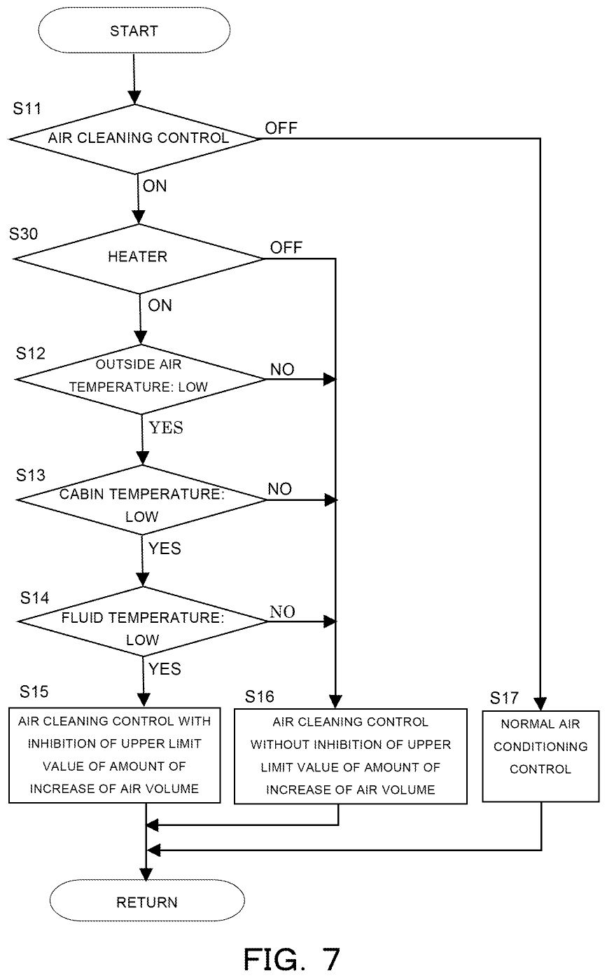

Next, an air conditioning device for vehicle of a third configuration will be described with reference to FIGS. 5 and 7. The air conditioning device for vehicle of the third configuration has a structure similar to that of the air conditioning device 10 for vehicle of the first configuration except that the air conditioning device has the heater 1, and differs from the air conditioning device 10 for vehicle of the first configuration in the control routine executed by the control device 30. Therefore, a control routine executed by the control device 30 of the air conditioning device for vehicle of the third configuration will be described, and descriptions of other structures will not be repeated.

FIG. 7 shows the control routine executed by the control device 30 of the air conditioning device for vehicle of the third configuration. This control routine differs from the control routine executed by the control device 30 of the air conditioning device 10 for vehicle of the first configuration and shown in FIG. 2 only in that a step S30 is provided between step S11 and step S12. Therefore, for the control routine executed by the control device 30 of the air conditioning device for vehicle of the third configuration and shown in FIG. 7, only step S30 will be described, and descriptions of the portions common with the control routine shown in FIG. 2 will not be repeated.

In the control routine executed by the control device 30 of the air conditioning device for vehicle of the third configuration, as shown in FIG. 7, when the processing proceeds from step S11 to step S30, in step S30, a determination is made as to whether or not the heater 1 is heating. When the heater 1 is heating, the processing proceeds from step S30 to step S12. When the heater 1 is not heating, the processing proceeds from step S30 to step S16.

As described, in the air conditioning device for vehicle of the third configuration, in a case in which the heater 1 is heating, under the air conditioning condition in which the increase of the cabin temperature is strongly demanded, when the fluid temperature is lower than the predetermined fluid temperature, the upper limit value which varies depending on the outside air temperature as shown in FIG. 5 is provided as the upper limit value permitted as the amount of increase of the air volume.

Because of this, in the air conditioning device for vehicle of the third configuration, in the case in which the heater 1 is heating the fluid, under the air conditioning condition in which the increase of the cabin temperature is strongly demanded, when the fluid temperature of the fluid which is the heat source for the indoor heating is lower than the predetermined fluid temperature, the upper limit value permitted as the amount of increase of the air volume by the air cleaning control is inhibited. Thus, the increase of the consumed electric power of the heater 11 can be inhibited, and, as a consequence, the degradation of the fuel consumption and the electric power consumption of the vehicle due to the air cleaning control can be inhibited.

### <Fourth Configuration>

An air conditioning device for vehicle of a fourth configuration will now be described with reference to FIGS. 5, 8, and 9. The air conditioning device for vehicle of the fourth configuration has a structure similar to that of the air conditioning device 10 for vehicle of the first configuration except that the air conditioning device comprises the heat pump 2, and differs from the air conditioning device 10 for vehicle of the first configuration in the control routine executed by the control device 30. Thus, a control routine executed by the control device 30 of the air conditioning device for vehicle of the fourth configuration will be described, and descriptions of other structures will not be repeated.

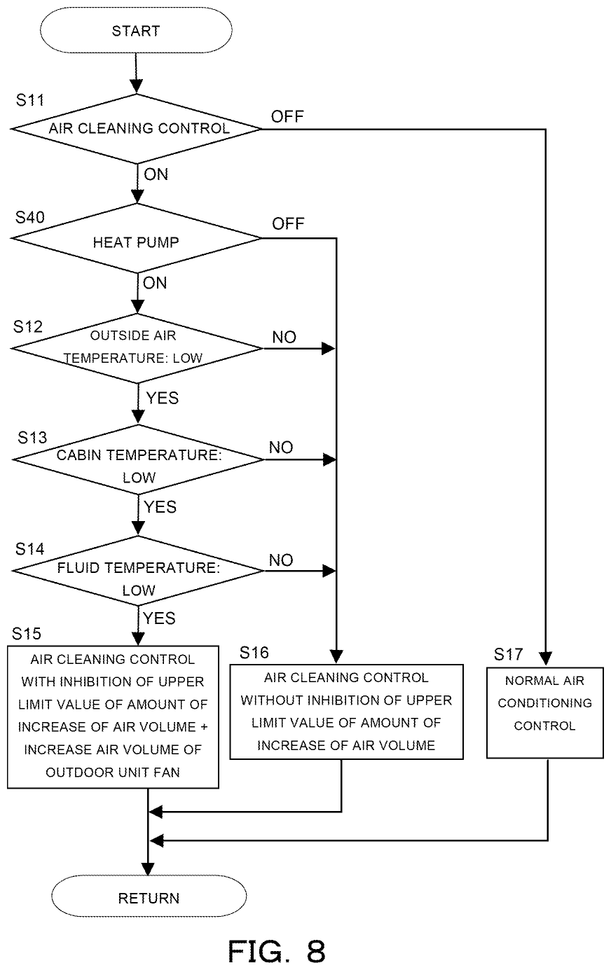

FIG. 8 shows the control routine executed by the control device 30 of the air conditioning device for vehicle of the fourth configuration. The control routine differs from the control routine executed by the control device 30 of the air conditioning device 10 for vehicle of the first configuration and shown in FIG. 2 in that a step S40 is provided between step S11 and step S12, and in that the heat pump 2 is also controlled in step S15. Thus, for the control routine executed by the control device 30 of the air conditioning device for vehicle of the fourth configuration and shown in FIG. 7, step S40 and the control of the heat pump 2 in step S15 will be described, and descriptions of the portions common with the control routine shown in FIG. 2 will not be repeated.

In the control routine executed by the control device 30 of the air conditioning device for vehicle of the fourth configuration, as shown in FIG. 8, when the processing proceeds from step S11 to step S40, in step S40, a determination is made as to whether or not the heat pump 2 is heating the air blowing out from the blower outlet into the vehicle cabin. When the heat pump 2 is heating, the processing proceeds from step S40 to step S12. When the heat pump 2 is not heating, the processing proceeds from step S40 to step S16.

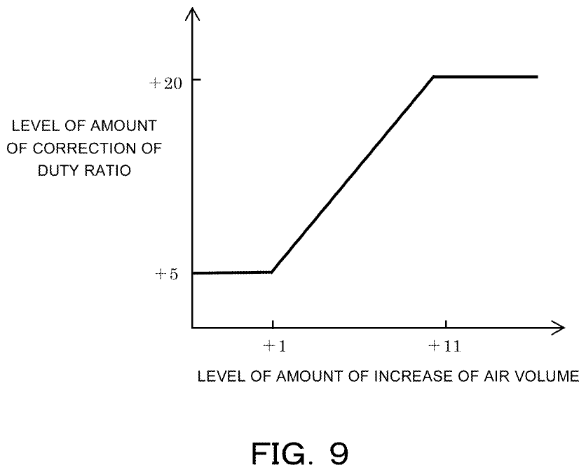

When the processing proceeds from step S14 to step S15, similar to the air conditioning device 10 for vehicle of the first configuration, the control device 30 executes the “air cleaning control with the inhibition of the upper limit value of the amount of increase of the air volume”. Further, in the air conditioning device for vehicle of the fourth configuration, in step S15, a blow rate of an outdoor unit fan of the heat pump 2 is increased according to the amount of increase of the air volume by the air cleaning control, to improve an indoor heating capability and an indoor heating efficiency. FIG. 9 shows a relationship between a level of the amount of increase of the air volume of the air blower 4 by the air cleaning control and a level of an amount of correction of a duty ratio of the outdoor unit fan of the heat pump 2. This relationship is stored in the ROM of the control device 30, and the control device 30 calculates the level of the amount of correction of the duty ratio of the outdoor unit fan from the level of the amount of increase of the air volume of the air blower 4 by the air cleaning control based on the relationship stored in the ROM and shown in FIG. 9, to thereby control the air blower 4 and the heat pump 2.

As described, in the air conditioning device for vehicle of the fourth configuration, in a case in which the heat pump 2 is heating the air blowing out into the vehicle cabin, under the air conditioning condition in which the increase of the cabin temperature is strongly demanded, when the fluid temperature is lower than the predetermined fluid temperature, the upper limit value which varies depending on the outside air temperature as shown in FIG. 5 is provided as the upper limit value permitted as the amount of increase of the air volume.

Because of this, in the air conditioning device for vehicle of the fourth configuration, in a case in which the heat pump 2 is heating the air blowing out into the vehicle cabin, under the air conditioning condition in which the increase of the cabin temperature is strongly demanded, when the fluid temperature of the fluid which is the heat source for the indoor heating is lower than the predetermined fluid temperature, the upper limit value permitted as the amount of increase of the air volume by the air cleaning control is inhibited. As a consequence, the increase of the consumed electric power of the heat pump 2 can be inhibited, and the degradation of the fuel consumption and the electric power consumption of the vehicle due to the air cleaning control can be inhibited.

Further, because the heat pump capability of the heat pump 2 is determined based on the outside air temperature, the air volume of the outdoor unit fan, and a compressor work, in the air conditioning device for vehicle of the fourth configuration, the blow rate of the outdoor unit fan of the heat pump 2 can be increased when the air volume passing through the heater core is increased as described above, to improve the indoor heating capability and the indoor heating efficiency. As a consequence, the fuel consumption and the electric power consumption of the vehicle can be improved.

### <Fifth Configuration>

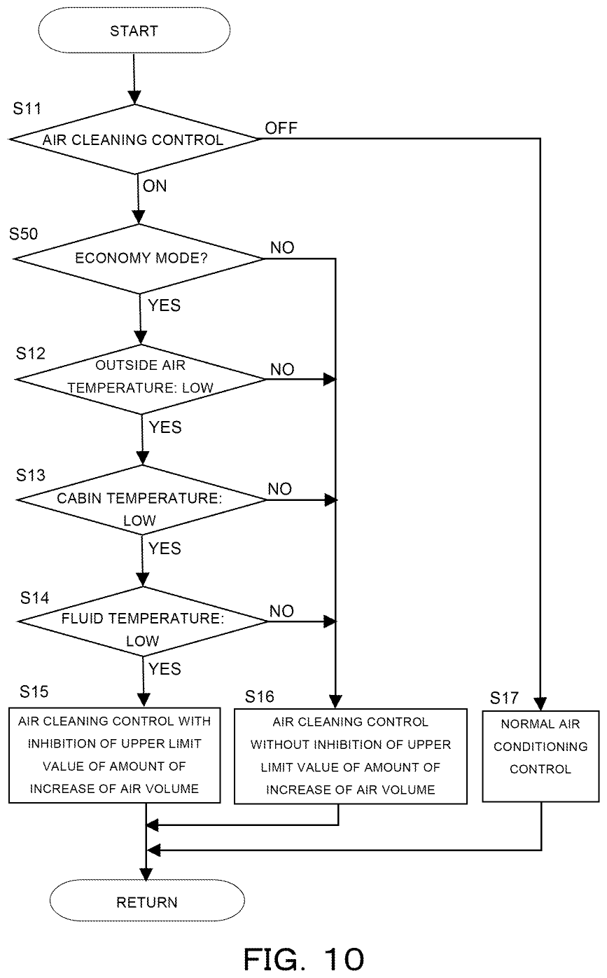

An air conditioning device for vehicle of a fifth configuration will now be described with reference to FIGS. 5 and 10. The air conditioning device for vehicle of the fifth configuration has a structure similar to that of the air conditioning device 10 for vehicle of the first configuration, and differs from the air conditioning device 10 for vehicle of the first configuration only in the control routine executed by the control device 30. Therefore, a control routine executed by the control device 30 of the air conditioning device for vehicle of the fifth configuration will be described, and descriptions of other structures will not be repeated.

FIG. 10 shows the control routine executed by the control device 30 of the air condition device for vehicle of the fifth configuration. The control routine differs from the control routine executed by the control device 30 of the air conditioning device 10 for vehicle of the first configuration and shown in FIG. 2 only in that a step S50 is provided between step S11 and step S12. Thus, for the control routine executed by the control device 30 of the air conditioning device for vehicle of the fifth configuration and shown in FIG. 10, only step S50 will be described, and descriptions of the portions common with the control routine shown in FIG. 2 will not be repeated.

In the control routine executed by the control device 30 of the air conditioning device for vehicle of the fifth configuration, as shown in FIG. 10, when the processing proceeds from step S11 to step S50, in step S50, a determination is made as to whether or not an economy mode intended to improve the fuel consumption in comparison to a standard mode is selected as a traveling mode of the vehicle. When the economy mode is selected, the processing proceeds from step S50 to step S12. When the economy mode is not selected, the processing proceeds from step S50 to step S16.

As described, in the air conditioning device for vehicle of the fifth configuration, in a case in which the economy mode is selected as the traveling mode of the vehicle, under the air conditioning condition in which the increase of the cabin temperature is strongly demanded, when the fluid temperature is lower than the predetermined fluid temperature, the upper limit value which varies depending on the outside air temperature as shown in FIG. 5 is provided as the upper limit value permitted as the amount of increase of the air volume.

Because of this, in the air conditioning device for vehicle of the fifth configuration, in the case in which the economy mode is selected as the traveling mode of the vehicle, under the air conditioning condition in which the increase of the cabin temperature is strongly demanded, when the fluid temperature of the fluid which is the heat source for the indoor heating is lower than the predetermined fluid temperature, the upper limit value permitted as the amount of increase of the air volume by the air cleaning control is inhibited. As a consequence, degradation of the fuel consumption and the electric power consumption of the vehicle due to the air cleaning control can be inhibited, and the discomfort of the passengers due to the cold air flow can be reduced.

### <Sixth Configuration>

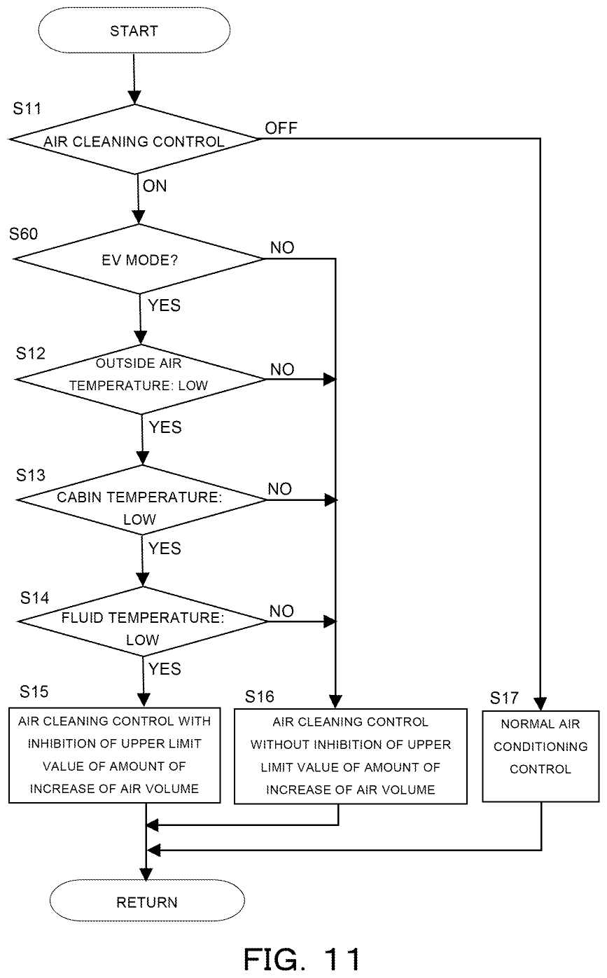

An air condition device for vehicle of a sixth configuration will now be described with reference to FIGS. 5 and 11. The air conditioning device for vehicle of the sixth configuration is equipped on a hybrid electric vehicle. The air conditioning device for vehicle of the sixth configuration has a structure similar to that of the air conditioning device 10 for vehicle of the first configuration, and differs from the air conditioning device 10 for vehicle of the first configuration only in the control routine executed by the control device 30. Thus, a control routine executed by the control device 30 of the air conditioning device for vehicle of the sixth configuration will be described, and descriptions of other structures will not be repeated.

FIG. 11 shows the control routine executed by the control device 30 of the air conditioning device for vehicle of the sixth configuration. The control routine differs from the control routine executed by the control device 30 of the air conditioning device 10 for vehicle of the first configuration and shown in FIG. 2 only in that a step S60 is provided between step S11 and step S12. Thus, for the control routine executed by the control device 30 of the air conditioning device for vehicle of the sixth configuration and shown in FIG. 11, only step S60 will be described, and descriptions of the portions common with the control routine shown in FIG. 2 will not be repeated.

In the control routine executed by the control device 30 of the air conditioning device for vehicle of the sixth configuration, as shown in FIG. 11, when the processing proceeds from step S11 to step S60, in step S60, a determination is made as to whether or not an EV mode which uses a main battery as a motive power source for traveling is selected as a traveling mode of the hybrid electric vehicle. When the EV mode is selected, the processing proceeds from step S60 to step S12. When the EV mode is not selected, the processing proceeds from step S60 to step S16.

As described, in the air conditioning device for vehicle of the sixth configuration, in a case in which the EV mode is selected as the traveling mode of the hybrid electric vehicle, under the air conditioning condition in which the increase of the cabin temperature is strongly demanded, when the fluid temperature is lower than the predetermined fluid temperature, the upper limit value which varies depending on the outside air temperature as shown in FIG. 5 is provided as the upper limit value permitted as the amount of increase of the air volume.

Because of this, in the air conditioning device for vehicle of the sixth configuration, in the case in which the EV mode is selected as the traveling mode of the hybrid electric vehicle, under the air conditioning condition in which the increase of the cabin temperature is strongly demanded, when the fluid temperature of the fluid which is the heat source of the indoor heating is lower than the predetermined fluid temperature, the upper limit value permitted as the amount of increase of the air volume by the air cleaning control is inhibited. As a consequence, degradation of the fuel consumption and the electric power consumption of the vehicle due to the air cleaning control can be inhibited, and the discomfort of the passengers due to the cold air flow can be reduced.

### Supplement to Embodiment

The air conditioning device for vehicle according to the present disclosure is not limited to the above-described configurations, and various configurations may be practiced within the spirit and scope of the present disclosure. For example, in the above-described configurations, under the air conditioning condition in which the increase of the cabin temperature is strongly demanded, when the fluid temperature of the fluid which is the heat source for the indoor heating is lower than the predetermined fluid temperature, the upper limit value which varies depending on the outside air temperature as shown in FIG. 5 is provided as the upper limit value permitted as the amount of increase of the air volume by the air cleaning control, but alternatively, the upper limit value may vary depending not on the outside air temperature, but on the cabin temperature or on the fluid temperature.

1. An air conditioning device for a vehicle in which air cleaning control can be executed to reduce a concentration of floating particulate substances in a vehicle cabin by increasing an air volume passing through a filter by further increasing an air volume blowing out from a blower outlet into the vehicle cabin from an air volume which is necessary for cabin temperature control or an air volume which is set by a passenger of the vehicle, by an air volume according to the concentration of the floating particulate substances in the vehicle cabin, wherein
under an air conditioning condition in which an increase of the cabin temperature is strongly demanded, when a fluid temperature of a fluid which is a heat source for indoor heating is lower than a predetermined fluid temperature, an upper limit value permitted as an amount of increase of an air volume by the air cleaning control is inhibited.

2. The air conditioning device for the vehicle according to claim 1, wherein
it is determined that the air conditioning condition is satisfied when an outside air temperature is lower than a predetermined outside air temperature and the cabin temperature is lower than a predetermined cabin temperature.

3. The air conditioning device for the vehicle according to claim 1, wherein
it is determined that the air conditioning condition is satisfied when a target blow-out temperature which is a target temperature of air blowing out from the blower outlet into the vehicle cabin for maintaining the cabin temperature at a set temperature is higher than a predetermined temperature.

4. The air conditioning device for the vehicle according to claim 2, further comprising:
a heater which heats the fluid, wherein
the upper limit value is inhibited when the heater is heating the fluid.

5. The air conditioning device for the vehicle according to claim 3, further comprising:
a heater which heats the fluid, wherein
the upper limit value is inhibited when the heater is heating the fluid.

6. The air conditioning device for the vehicle according to claim 2, further comprising:
a heat pump for indoor heating, wherein
the upper limit value is inhibited when the heat pump is heating air blowing into the vehicle cabin.

7. The air conditioning device for the vehicle according to claim 3, further comprising;
a heat pump for indoor heating, wherein
the upper limit value is inhibited when the heat pump is heating air blowing into the vehicle cabin.

8. The air conditioning device for the vehicle according to claim 2, wherein
the upper limit value is inhibited when an economy mode intended to improve fuel consumption in comparison to a standard mode is selected as a traveling mode of the vehicle.

9. The air conditioning device for the vehicle according to claim 3, wherein
the upper limit value is inhibited when an economy mode intended to improve fuel consumption in comparison to a standard mode is selected as a traveling mode of the vehicle.

10. The air conditioning device for the vehicle according to claim 2, wherein
the air conditioning device is equipped on a hybrid electric vehicle, and
the upper limit value is inhibited when an EV mode which uses a main battery as a motive power source for traveling is selected as a traveling mode of the hybrid electric vehicle.

11. The air conditioning device for the vehicle according to claim 3, wherein
the air conditioning device is equipped on a hybrid electric vehicle, and
the upper limit value is inhibited when an EV mode which uses a main battery as a motive power source for traveling is selected as a traveling mode of the hybrid electric vehicle.
